(19) United States
(12) Patent Application Publication
(10) Pub. No.: US 2004/0262096 A1
(43) Pub. Date: Dec. 30, 2004

(54) Heat dissipation for an electric brake assembly

(75) Inventors: John B. Hageman, Vandalia, OH (US); Ernst S. Baumgartner, Dayton, OH (US); Paul Rymoff JR., Bellbrook, OH (US)

Correspondence Address: SCOTT A. MCBAIN, DELPHI TECHNOLOGIES, INC., Legal Staff, Mail Code: 480-410-202, P.O. BOX 5052, Troy, MI, 48007, US

(73) Assignee: DELPHI TECHNOLOGIES INC.

(21) Appl. No.: 10/609,167

(22) Filed: Jun. 27, 2003

(51) Int. Cl. F16D 55/02

(52) U.S. Cl. 188/71.6

(57) ABSTRACT

Brake assemblies and a method of dissipating heat from a brake assembly are provided. A first brake assembly includes a rotor, a brake caliper assembly including an actuator motor, and at least one friction pad operably attached to the caliper assembly. The actuator motor biases the friction pad into frictional engagement with the rotor. At least one thermal conduit extends distally from the actuator motor dissipating heat energy away from the actuator motor. The method includes providing an actuator motor and providing a thermal conduit extending distally from the actuator motor. Heat is conducted away from the actuator motor along the thermal conduit. A second brake assembly includes actuator motor means and thermal conduit means extending distally from the actuator motor means. The brake assembly further includes means for conducting heat from the actuator motor means along the thermal conduit means.

### TECHNICAL FIELD OF THE INVENTION

The present invention relates to disc brakes, and more specifically, the invention relates to strategies for dissipating heat in an electric brake assembly.

### BACKGROUND OF THE INVENTION

Virtually all wheeled vehicles utilize braking systems to selectively inhibit wheel rotation and, therefore, reduce vehicle speed. Braking may be accomplished by the use of a disc braking system whereby a friction force is applied at one or more wheel assemblies to inhibit wheel rotation. Numerous disc brake systems are known in the art. During its use, the vehicle operator typically generates a brake force or signal through a pedal thereby activating the disc brake system. The system generally includes a rotor or disc secured to the vehicle wheel, a caliper assembly mounted to the vehicle chassis, and a pair of friction pads (also called brake pads or brake linings) disposed on opposing sides of the rotor. Upon activation of the disc brake system, the friction pads are moved toward one another by one or more caliper pistons into frictional engagement with the rotor thereby actuating the braking force and slowing the vehicle. The caliper piston(s) may be moved via coupled hydraulics, electric motor(s), or electro-hydraulic means.

A moving vehicle has a certain amount of kinetic energy, and the brake system needs to dissipate this energy in order to stop it. As such, the frictional engagement of the pads and rotor results in the conversion of kinetic energy into heat. One concern in brake system designs relates to the conduction of the generated heat from the pads/rotor into the caliper, which may result in damage to internal components. In the case of hydraulic caliper assemblies, the generated heat may potentially damage caliper seals and/or vaporize hydraulic fluid in the caliper piston.

Another concern relates to brake assemblies that include motor(s). Heat is produced by the motor as it repeatedly moves the piston(s) and actuates braking cycles. The heat produced by the motor(s) may potentially damage the motor and/or other caliper components. Accordingly, it would be desirable to provide a strategy for dissipating heat produced by brake caliper motors.

Numerous strategies have been developed for limiting the amount of heat conducted into the caliper assembly from various components. One strategy includes vented rotors that pump air through the disc thereby augmenting cooling. This cooling solution may provide adequate dissipation of heat generated by the frictional engagement of the pads and the rotor. However, in the case of an electrical caliper design, heat generated by the actuator motor may require additional cooling strategies. To dissipate this additional heat, the mass of the brake assembly may be purposely increased thereby enhancing its heat capacity. This strategy may not be a practical cooling solution as it may increase the cost, size, and/or complexity of the brake system. Accordingly, it would be desirable to provide a strategy for dissipating heat generated by the actuator motor of an electric brake caliper without significantly increasing the mass of the brake assembly.

Therefore, it would be desirable to provide a strategy dissipating heat in an electric brake assembly that overcomes the aforementioned and other disadvantages.

### SUMMARY OF THE INVENTION

A first aspect of the invention provides a brake assembly. The brake assembly includes a rotor, a brake caliper assembly including an actuator motor, and at least one friction pad operably attached to the brake assembly. The actuator motor biases the friction pad into frictional engagement with the rotor. At least one thermal conduit extends distally from the actuator motor dissipating heat energy away from the actuator motor.

A second aspect of the invention provides a method of dissipating heat from a brake assembly. An actuator motor is provided. A thermal conduit extending distally from the actuator motor is provided. Heat is conducted away from the actuator motor along the thermal conduit.

A third aspect of the invention provides a brake assembly. The brake assembly includes actuator motor means and thermal conduit means extending distally from the actuator motor means. The brake assembly further includes means for conducting heat from the actuator motor means along the thermal conduit means.

The foregoing and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a perspective view of a vehicle disc brake assembly in accordance with the present invention;

FIG. 2 is an alternative perspective view of the vehicle disc brake assembly shown in FIG. 1; and

FIG. 3 is a perspective view of thermal conduits operably attached to an actuator motor in accordance with the present invention.

### DETAILED DESCRIPTION OF THE PRESENTLY PREFERRED EMBODIMENTS

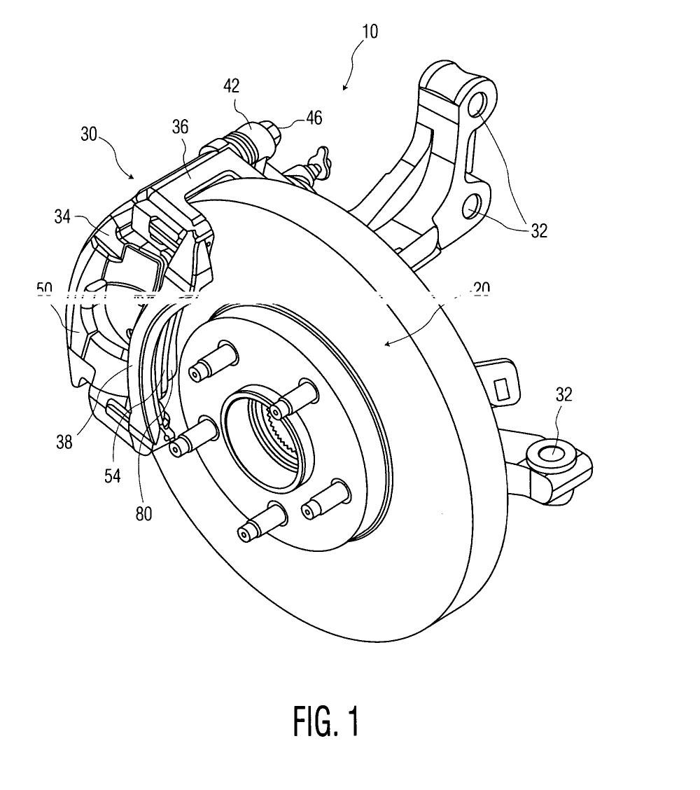

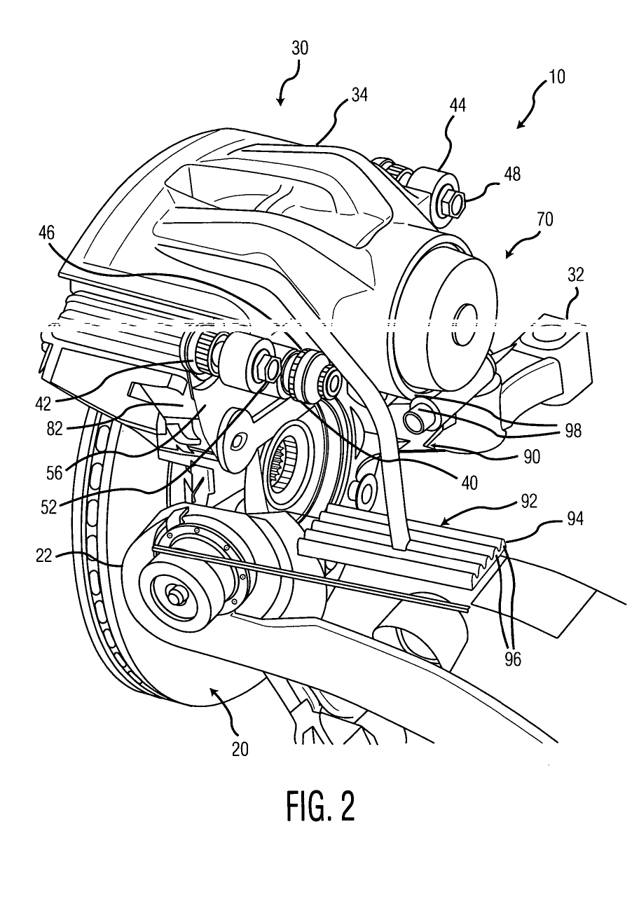

Referring to the drawings wherein like numerals refer to like elements, FIGS. 1 and 2 are alternative perspective views of a vehicle brake assembly in accordance with the present invention and indicated generally by numeral 10. Those skilled in the art will recognize that while the present invention is described for use with particular disc brake structures shown in the drawings, the invention may also be adapted for use with other disc brake designs such as electro-hydraulic disc and drum brakes used in a variety of applications.

Brake assembly 10 includes a rotor 20, a brake caliper assembly 30 including an actuator motor 70, and at least one, in this case two, friction pads 80, 82 operably attached to the assembly 30. In one embodiment of the present invention, the brake assembly 10 may include means 32 for attaching the assembly 10 to a chassis (not shown). The brake assembly attachment means 32 may comprise mounting points that permit a plurality of mounting bolts (not shown) to be threaded therethrough. Those skilled in the art will recognize that numerous attachment means may be utilized to attach a disc brake assembly to the vehicle chassis. Assembly 30 may further include a caliper 34, bracket 36, tie bar 38, 40, and two caliper ears 42, 44 each including a sliding bolt 46, 48.

Caliper 34 may be generally C-shaped flanking a portion of the rotor 20. Rotor 20 may be vented whereby a plurality of vanes 22 are positioned between two sides of the disc to pump air therebetween thereby providing cooling. Caliper 34 may include an outboard leg assembly 50 slidably connected to an opposing inboard leg and boot assembly 52. Outboard leg assembly 50 may include an outboard backing plate 54 for carrying the friction pad 80. Inboard leg and boot assembly 52 may likewise include an inboard backing plate 56 for carrying the friction pad 82. Outboard leg assembly 50 and inboard leg and boot assembly 52 may be operably attached to the caliper 34 by the bracket 36, caliper ears 42, 44, and sliding bolts 46, 48. Bolts 46, 48 may be slidably carried with apertures formed within the caliper 34. Caliper 34 is preferably designed to allow for the slidable movement of the bolts 46, 48 while providing a seal from external elements (e.g., salt, asphalt, dirt, fluids, etc.).

Assembly 30 may be of a single-piston floating caliper disc design, which is self-centering and self-adjusting as understood in the art. It will be appreciated that other brake designs may be adapted for use with the present invention. Numerous strategies may be used for moving the friction pads 80, 82 into frictional engagement with the rotor 20. In one embodiment, brake actuation is achieved when the actuator motor 70 is activated by a brake-by-wire signal. Actuator motor 70 may force a piston carried within a bore formed in the inboard leg and boot assembly 52 to slide toward and engage the inboard backing plate 56. The inboard leg and boot assembly 52 and associated friction pad 82 are pushed toward the rotor 20. Concurrently, the outboard leg assembly 50 engages the outboard backing plate 54 and friction pad 80 resulting in their movement toward the rotor 20. As such, the caliper 34 “clamps” the rotor 20 with the friction pads 80, 82 thereby applying pressure to achieve vehicle braking.

At least one thermal conduit 90 is provided for dissipating heat energy away from the actuator motor 70. Thermal conduit 90 extends distally from the actuator motor 70. In one embodiment, the thermal conduit 90 may be manufactured substantially from a material such as aluminum, copper, brass, nickel, steel, a metal, a metal alloy, a composite, and the like. In one embodiment, thermal conduit 90 has a thermal conductivity greater than that of the assembly 30. In another embodiment, the thermal conduit 90 may be manufactured from any material capable of efficiently conducting heat.

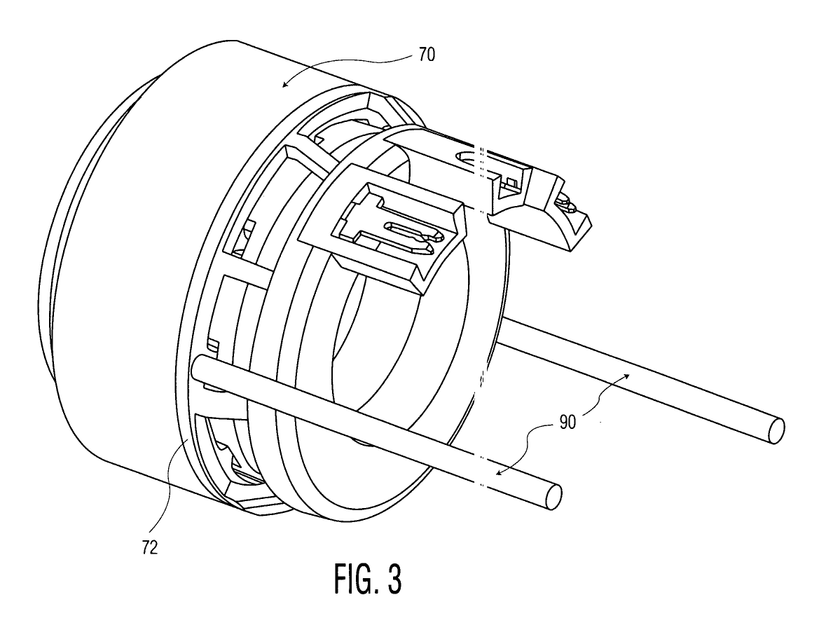

Thermal conduit 90 may comprise an elongated member including one or more apertures formed therethrough for conducting heat along its length. The apertures may carry a fluid therein for conducting heat. Such “heat-pipes” may include a variety of geometries, sizes, and cross-sectional shapes (e.g., square, round, elliptical, etc.) and are known to and may be constructed by one skilled in the art. In one embodiment, the thermal conduit 90 may be attached to the caliper 34 and conduct heat distally to a dissipation site 92. Dissipation site 92 may comprise a heatsink member 94 including a plurality of fins 96 and/or a component of the vehicle suspension such as the suspension arm. Thermal conduit 90 may include one or more flexible portions 98 thereby allowing, for example, movement of the caliper 34 relative to the dissipation site 92. Dissipation site 92 may augment the heat dissipation through an additional thermal capacity without requiring an increased mass of the assembly 10. Furthermore, structures such as the fins 96 may provide increased surface area to enhance heat convection from the dissipation site 92. In another embodiment, as shown in FIG. 3, the thermal conduit 90 may be operably attached to a stator 72 portion of the actuator motor 70 or any other portion capable of conducting heat from the actuator motor 70.

Regardless of the positioning of the thermal conduit 90, the conduction of heat from the actuator motor 70 is preferably enhanced by manufacturing the thermal conduit 90 from an included material with a thermal conductivity greater than the material of the assembly 30. In addition, the dissipation site 92 may include a material with a thermal conductivity greater than the material of the thermal conduit 90. As such, heat is channeled away from the actuator motor 70 and may be conducted to a dissipation site 92 “heat-sink”. It should be noted that the thermal conduit 90 is not limited to the thermal conductivity of heat generated by the actuator motor 70. For example, the thermal conduit 90 may conduct heat generated by the assembly 10 components other than the actuator motor 70, such as the heat produced by the engagement of the friction pads 80, 82 and rotor 20. Those skilled in the art will recognize that the size, shape, configuration, number, material, points of attachment, and heat conductivity pathway of the thermal conduit 90 and dissipation site 92 may vary while still providing adequate heat dissipation of the actuator motor 70.

While the embodiments of the invention disclosed herein are presently considered to be preferred, various changes and modifications can be made without departing from the spirit and scope of the invention. For example, the described brake and caliper assemblies and method of dissipating heat are not limited to any particular design or sequence. Specifically, the brake and thermal conduit design, type, material, geometry, position, configuration, thermal conductivity and pathway, and component material may vary without limiting the utility of the invention.

Upon reading the specification and reviewing the drawings hereof, it will become immediately obvious to those skilled in the art that myriad other embodiments of the present invention are possible, and that such embodiments are contemplated and fall within the scope of the presently claimed invention. The scope of the invention is indicated in the appended claims, and all changes that come within the meaning and range of equivalents are intended to be embraced therein.

1. A brake assembly comprising:
a rotor:
a brake caliper assembly including an actuator motor;
at least one friction pad operably attached to the caliper assembly, wherein the actuator motor is operable to force the friction pad into frictional engagement with the rotor; and
at least one thermal conduit extending distally from the actuator motor for dissipating heat energy away front the actuator motor.

2. The assembly of claim 1 wherein the thermal conduit comprises a material having a thermal conductivity greater than that of the brake caliper assembly.

3. The assembly of claim 1 wherein the thermal conduit comprises at least one elongated member.

4. The assembly of claim 1 wherein the thermal conduit comprises at least one flexible member.

5. The assembly of claim 1 wherein the thermal conduit comprises a heat pipe.

6. The assembly of claim 1 wherein the thermal conduit is operably attached to a suspension component.

7. The assembly of claim 1 wherein the thermal conduit is operably attached to an actuator motor stator.

8. The assembly of claim 1 wherein the thermal conduit is manufactured substantially from a material selected from a group consisting of aluminum, copper, brass, nickel, steel, a metal, a metal alloy, and a composite.

9. The assembly of claim 1 further comprising a heatsink member operably attached to the thermal conduit, the heatsink member including a plurality of fins.

10. A method of dissipating beat from a brake assembly, the method comprising:
providing an actuator motor;
providing a thermal conduit extending distally from the actuator motor; and
conducting heat away from the actuator motor along the thermal conduit.

11. The method of claim 10 wherein conducting heat from the actuator motor along the thermal conduit comprises transferring heat from a first material to a second material wherein the second material comprises a thermal conductivity greater than the first material.

12. The method of claim 10 further comprising moveably flexing the thermal conduit.

13. The method of claim 10 further comprising providing a dissipation site thermally coupled to the thermal conduit.

14. The method of claim 13 further comprising convecting heat from the dissipation site.

15. The method of claim 13 further comprising conducting heat from a brake assembly component other than the actuator motor.

16. A brake assembly comprising:
actuator motor means;
thermal conduit means extending distally from the actuator motor means; and
means for conducting heat from the actuator motor means along the thermal conduit means.

17. The assembly of claim 16 further comprising means for flexing the thermal conduit means.

18. The assembly of claim 16 further comprising dissipation site means thermally coupled to the thermal conduit means.

19. The assembly of claim 18 further comprising means for convecting heat from the dissipation site means.

20. The assembly of claim 16 further comprising means for conducting heat from a brake assembly component other than the actuator motor means.
